(19) United States
(12) Patent Application Publication
(10) Pub. No.: US 2015/0106160 A1
(43) Pub. Date: Apr. 16, 2015

(54) Telecommunication system, apparatus, and method for capture, certification, distribution, and contact of online generated sales leads

(71) Applicant: Clickpoint Software, Inc., Scottsdale, AZ (US)

(72) Inventor: Gabriel C. Buck, Scottsdale, AZ (US)

(21) Appl. No.: 14/512,628

(22) Filed: Oct. 13, 2014

Related U.S. Application Data
(60) Provisional application No. 61/890,829, filed on Oct. 14, 2013.

(51) Int. Cl. G06Q 30/02

(52) U.S. Cl. CPC G06Q 30/0201
USPC 705/7.29

(57) ABSTRACT

A telecommunication system for lead capture, certification, distribution, and contact can include a lead certification server, a lead certification database, a lead certification device, and a phone switch. The lead certification server can dynamically generate a consent agreement text of a lead capture form, based on information stored and issued from the lead certification database, so that the system can store the consumer consent of an agreement text, and connect a phone call to the consumer via the phone switch. A lead certification device can include a processor, non-transient memory, an input/output, a content display an information capture component, and a submission processor component. Also disclosed is a computer-implemented method including displaying content, capturing information, obtaining consent, processing a submission, and completing the submission.

### CROSS-REFERENCE TO RELATED APPLICATIONS

This application claims the benefit of U.S. Provisional Application No. 61/890,829, filed Oct. 14, 2013.

### FIELD OF THE INVENTION

The present invention relates generally to the field of online lead generation and more specifically to the concept of enhanced methods of capturing lead information while obtaining validated consumer consent, in the context of contacting a consumer via phone or email.

### BACKGROUND OF THE INVENTION

Congress enacted the Telephone Consumer Protection Act (TCPA) in 1991 as a response to a growing number of consumer complaints regarding telemarketing calls. The Federal Communications Commission (FCC) has implemented rules and regulations that define “telemarketing” as “the initiation of a telephone call or message for the purpose of encouraging the purchase or rental of, or investment in, property, goods, or services, which is transmitted to any person.”

The online lead generation industry, sales industry, and call centers are affected by these new TCPA requirements in ways that require both time and resource allocation. Marketers in all industries must implement appropriate protections to ensure they do not assume liability for themselves or their clients.

As the telemarketing industry has expanded, the FCC has adopted additional protections that include restrictions on autodialed calls or text messages as well as pre-recorded messages. Autodialed calls are defined as calls involving a live person or pre-recorded message that is placed by an automatic telephone dialing system that has the capacity to produce, store and call telephone numbers using a random or sequential number generator. This definition is broad enough to include “click-to-dial” systems as well.

For many in the lead generation, sales, telemarketing, and online marketing space the new requirements of the Telephone Consumer Protection Act have been crippling. Trying to determine what and how to respond to new legislation enacted by the FCC is time consuming, stressful, and costly.

As of Oct. 16, 2013, a telemarketer, salesperson, or marketer is required to obtain express written consent for all autodialed calls or text messages as well as pre-recorded messages made to a residential landline and cell phones for marketing purposes. Compliance with the Federal E-Sign Act satisfies this requirement by use of agreements obtained via email, website form, text message, telephone key press or voice recording. To comply with the new rule, the consumer must receive a “clear and conspicuous disclosure” that the customer will receive future calls that deliver autodialed and/or pre-recorded telemarketing messages on behalf of a specific marketer; that the customer's consent is not a condition of purchase; and that the customer must designate a phone number at which to be contacted.

The process of scoring and certifying leads has become more prevalent as consumers and companies have become increasingly conscious about the privacy of consumer digital information. Data and consumer verification companies have provided ways to use vast databases of US consumer information to confirm consumer identity when applying online for a good or service. Many companies provide services, such as reverse IP address, to verify that a consumer has voluntarily given their information online. Other services provide reverse telephone lookup, address appending, phone verification, name verification, and age verification.

With the changing TCPA regulations issued by the FCC, it is now vital that companies ensure that they are providing clear consent text on all online communication where a consumer could request information, a product, or service. This consent text should clearly state that the consumer is willing to be called via their cell phone, even if they provide a landline number.

With more and more households moving away from traditional land-line phone numbers and moving to cell phones this creates a massive liability issue for the lead generation industry valued at nearly 2 billion annual revenue, as well as any company that collects online leads created on websites, landing pages, and forms.

As such, it may be appreciated that there continues to be a need for novel and improved methods and devices for lead capture, lead certification, and lead distribution.

### SUMMARY OF THE INVENTION

The foregoing needs are met, to a great extent, by the present invention, wherein in aspects, enhancements are provided to the existing models for capturing lead information and certifying consumer consent.

The technologies and solutions of the past, prior to the aforementioned new amendment to the law, only focused on verification that the consumer was who they said they were when they applied online for goods or services. These previous solutions never focused on verifying that consent to be called via a cell phone number was given while the consumer was present on the web page they used to collect their information.

Various aspects of the present invention provide solutions that ensure the consent text is present, verified, and that the consumer is verified in the same process. It is evident that the process to improve this verification is not only valuable but will in the future be vital to the success and sustainability of many companies that get consumer leads from web pages.

Aspects of the present invention provide an enterprise solution for lead capture, lead certification, lead distribution, and lead contact, designed to help marketers in both the corporate and online lead generation industries. If a dispute should arise, solutions in accordance with the various aspect of the present invention can protect from liabilities and risks of any imposed fines from government organizations or from lawyers representing consumers or groups of consumers.

In an aspect, a telecommunication system for lead capture, certification, distribution, and contact can include a lead certification server, a lead certification database, a lead certification device, and a phone switch.

In a related aspect, the lead certification server can dynamically generate a consent agreement text of a lead capture form, based on information stored and issued from the lead certification database, so that the system can store the consumer consent of an agreement text, and connect a phone call to the consumer via the phone switch.

In aspects of this invention, an accurate log can be captured of what transpired and when, while a consumer was filling out a form or otherwise engaged on a marketing website. Such records can be maintained for up to 5 years to ensure compliance with the TCPA requirements.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram illustrating a telecommunication system for lead capture, certification, distribution, and contact, according to an embodiment of the invention.

FIG. 2 is a schematic diagram illustrating a lead certification device, according to an embodiment of the invention.

FIG. 3 is a schematic diagram illustrating a lead certification server, according to an embodiment of the invention.

FIG. 4 is a schematic diagram illustrating a method or process for lead capture, certification, and distribution, according to an embodiment of the invention.

### DETAILED DESCRIPTION

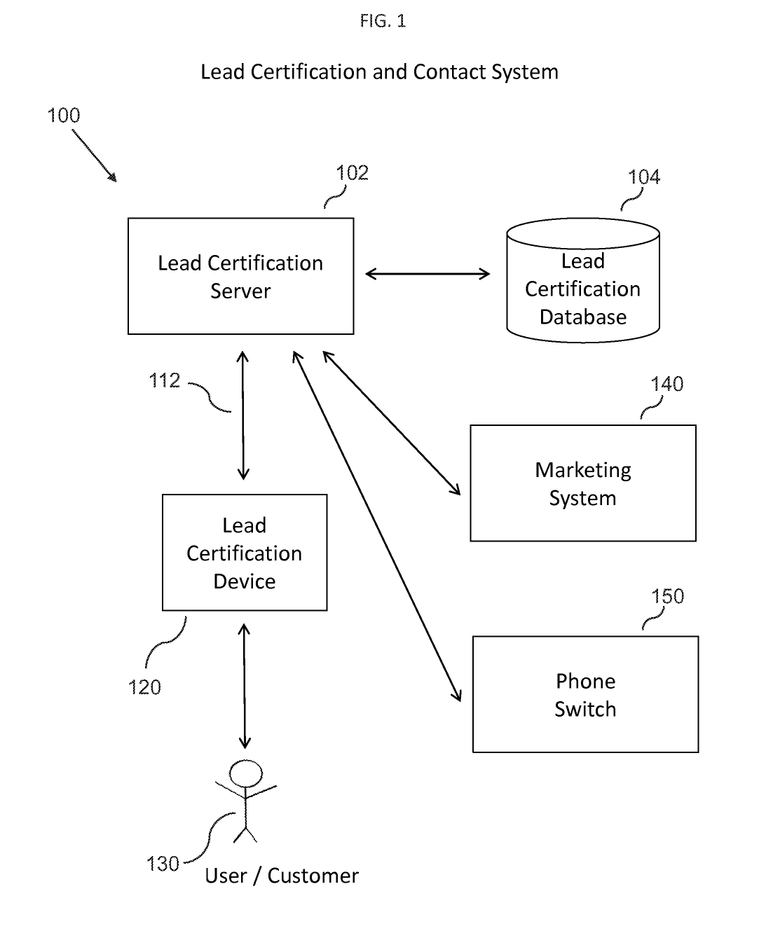

In the following, we describe the structure of an embodiment of the lead certification system 100 with reference to FIG. 1, in such manner that like reference numerals refer to like components throughout; a convention that we shall employ for the remainder of this specification.

In an embodiment, a lead certification system 100 can comprise:
a. A lead certification server 102;
b. A lead certification database 104; and a
c. A lead certification device 120;
Wherein the lead certification server 102 can dynamically generate a lead capture form, including a consent agreement text, based on consumer information stored and issued from the lead certification database 104, wherein the lead certification device 120 can further process tracking the display of the lead capture form, and IP address of a user 130, who is filling out the lead capture form, which can also be a landing page form, or website form. Event capture information, including the filled out lead capture form, is then stored via the lead certification server 102 in the lead certification database 104, to validate that the user 130, identified via an IP address, was served the consumer information on the site and that it was displayed at the time the lead capture form was submitted to a server with a database for capturing and storing this information.

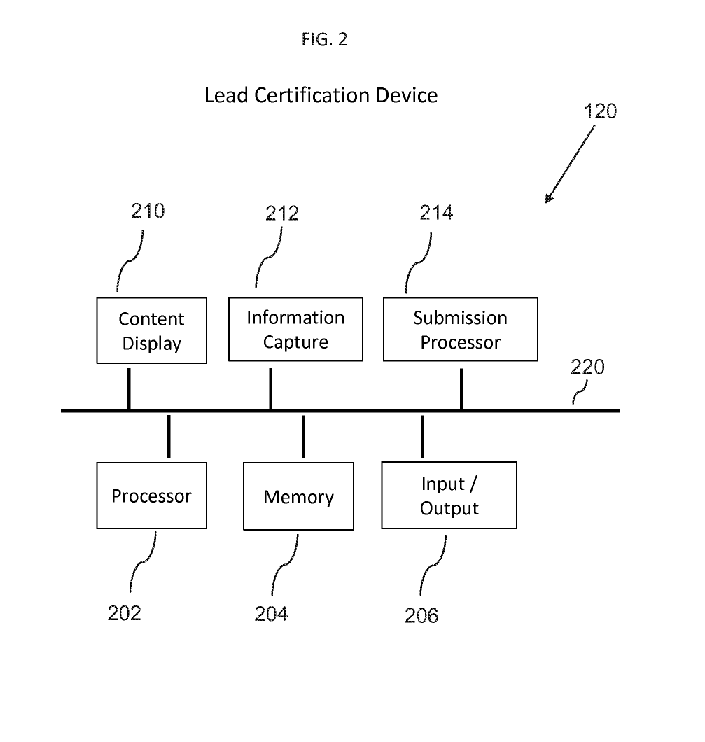

In a related embodiment, illustrated in FIG. 2, a lead certification device 120 can comprise:
a. A processor 202;
b. A memory 204;
c. A input/output component 206;
d. A content display component 210;
e. An information capture component 212; and
f. A submission processor component 214; all connected via
g. A data bus 220;
wherein computer generated content can be displayed to a customer to convey information about products being offered for the purpose of collecting contact information.

In related embodiments, the lead certification device 120 can include:
a. a web application, executing in a web browser;
b. a tablet app, executing on a tablet device, such as for example an Android or iOS tablet device;
c. a mobile app, executing on a mobile device, such as for example an Android phone or iPhone, or a wearable mobile device;
d. a desktop application, executing on a personal computer, or similar device;
e. an embedded application, executing on a processing device, for example in a vehicle, an automated teller machine, or other systems.

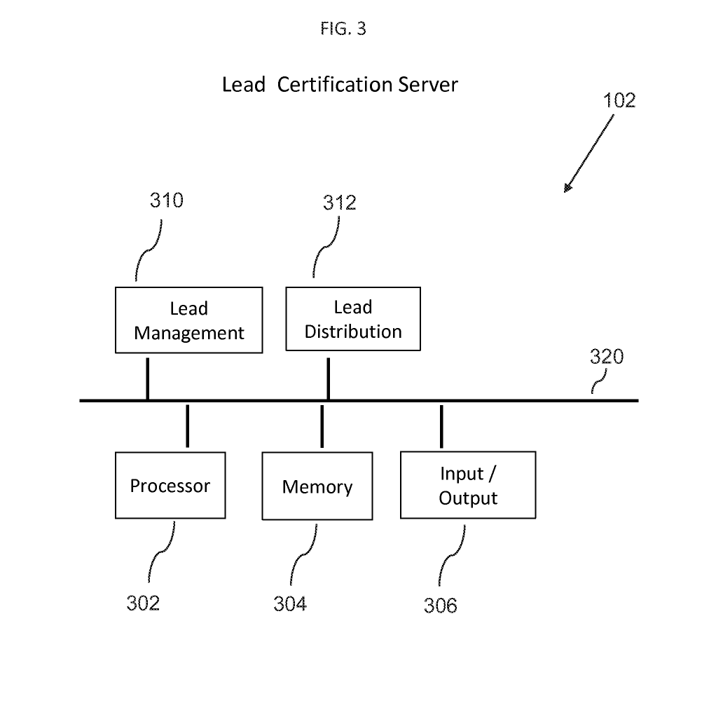

In a related embodiment, illustrated in FIG. 3, a lead certification server 102 can comprise:
a. A processor 302;
b. A memory 304;
c. A input/output component 306;
d. A lead management component 310; which can dynamically generate a lead capture form, including a consent agreement text as part of, based on consumer information stored and issued from the lead certification database 104, and further can store, retrieve and manage event capture information in the lead certification database 104;
e. A lead distribution component 312; all connected via
f. A data bus 320;

In a related embodiment, the lead certification server 102, can generate a code fragment for tracking a user, referred to as a lead generated tracking code snippet, which is executed by the lead certification device 120. The lead generated tracking code snippet can for example be generated in JavaScript, suitable for instances of the lead certification device 120 executing in a web browser environment. The tracking code will assign a unique ID to the visit event associated with the user. This will provide the ability for the receiving lead certification server to receive analytic data that will be stored for each page visited on a website through the use of the lead certification device's 120 application programming interface provided via the input/out component 206; Including any information captured by a lead capture form configured to execute as part of the information capture component 212. The analytic data captured includes IP address, browser user agent, and referring location. Additionally, further information such as search term, operating system, browser type and version can be extracted from the browser's user agent.

In a related embodiment, the lead certification server 102 can generate a lead form capture code snippet. The lead form capture code can be required to provide access to the dynamic consent system, and can be used by the form to allow the user to connect to the lead distribution component 312 of the lead certification server 102.

In a related embodiment, the information capture component 212, of the lead certification device 120, can be configured to present the user with an information capture screen that can collect personal information about the user, for the purpose of marketing, or supplying interest in purchasing, or subscribing to the use of a company's products or services.

In a further related embodiment, the information capture component 212, of the lead certification device 120, can be configured to execute lead form capture code that can communicate with the lead certification server. The user's IP and a date/stamp can be associated with a request for consent text copy, which can be returned and rendered as part of the form. The area that this code will render the consent text to will be labeled by the form's designer and inserted where needed for proper visibility by the end user. The consent text is supplied by lead certification server 102, and retrieved from the lead certification database 104. The text of the consent, the user ID, IP address, and a date/time stamp of the consent accept, will be logged by the lead certification server 102.

In a related embodiment, the submission processor component 214, of the lead certification device 120, can be configured to process the information captured by the information capture component 212. This information is sent via HTTP POST or HTTP GET to the distribution software's application programming interface to be processed. The submission processor is responsible for creating the outgoing request as well as parsing the incoming response.

In a related embodiment, the lead distribution component 312, of the lead certification server 102, can be configured with a geolocation function to determine and store the approximate physical location associated with a user's IP address, acquired from filling out the form. The geolocation function can use methods well-known in the art for determining a location of a device with a given IP address, including use of external web services.

In a related embodiment, the lead distribution component 312, of the lead certification server 102, can be configured to determine the phone number type, including either a mobile or landline type, of a primary phone number entered through the form. The phone number type information is then stored in the lead certification database 104. The phone number type determination can use methods well-known in the art, such as including table look-up.

In a related embodiment, the lead distribution component 312 of the lead certification server 102 can be configured to execute a double opt-in email procedure, wherein the lead distribution component 312 can send a template driven verification email to the email address supplied with the lead information. This verification email can contain a web link, wherein the web link can provide a log of the consent acquired. The verification email can also include questions and request more information that can be used to track intent to purchase, use, or subscribe to products or services. A template driven landing page, or redirection to a landing page, can be used when the link is clicked on through the user's email client. A date and time stamp for the user 130 click action, as well as any relevant information captured by the landing page can be stored by the lead certification server 102 in the lead certification database 104.

In a related embodiment, the lead distribution component 312 of the lead certification server 102 can be configured to send a form completion response back to the lead certification device 120, for presentation of a result to the user 130. The display of the result can be controlled by a form designer.

In further related embodiments, some or all of the functionality provided by the content display 210, information capture 212, and submission processor 214 components of the lead certification device 120, can be configured to execute on the lead certification server 102.

In related embodiments, the system for lead certification 100, can deliver consumer information in real-time to any call center, software solution, via email, SMS, and post, whereby it can be ensured that a sales team, lead buyers, or a call center have this information in real-time to avoid costly mistakes.

In a related embodiment, the system for lead certification 100 can further include a phone switch 150, such that the lead distribution component 312 can be configured to validate that a consumer has provided consent by lookup in the lead certification database 104, provided in communication with the lead management component 310, and if consent is confirmed, connecting a call to the consumer via communication with the phone switch 150.

In a related embodiment, an external marketing system 140, for managing email and telephone based marketing campaigns, can communicate with the lead certification server 102, in order to create, process, confirm, and delete lead information, including consumer consent information.

In various related embodiments, some or all of the functionality configured to execute on the lead certification server 102, can be configured to execute on the lead certification device 120.

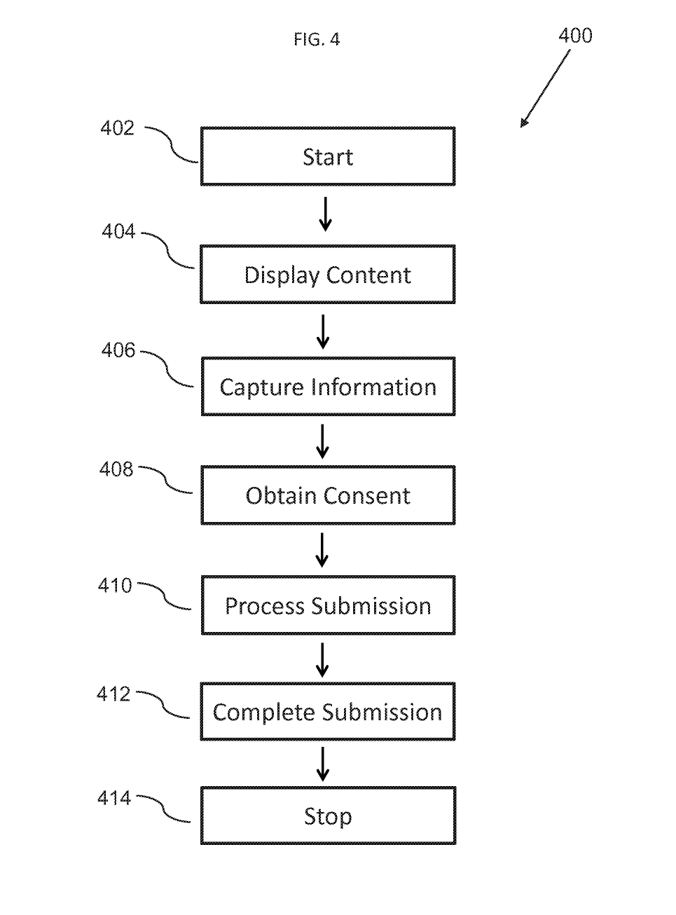

In an embodiment, illustrated in FIG. 4, a computer-implemented method for lead capture, certification, and distribution can comprise:
a. Displaying content 404;
b. Capturing information 406; wherein various information can be captured, including analytic information about a consumer, such as time on site, pages visited, and referring keywords.
c. Obtaining consent 408; wherein a provider's desired consent text can be served on third party and internal web forms, the consent status can be checked, including if the text is on a form or web-page, and it can be verified that the displayed consumer consent text was viewed when the consumer submitted their information, and a unique certification ID for each submission along with the consent approval is stored;
d. Processing a submission 410;
e. Completing the submission 412.

In a related embodiment of the computer-implemented method for lead capture, certification, and distribution, the action of obtaining consent 408, can further include:
a. real-time phone verification that provides a reverse look up on a submitted land-line phone number, and indication if it is a mobile phone number
b. IP address verification to be used as unique consumer verification to ensure that the consumer matches the submitted online request.
c. Storing copies of the landing page URL, analytic information such as referrer and keyword, and the consent text present on the web page for up to 5 years.
d. Printing consumer consent and all accompanying information in the event it is needed to show proof that a particular consumer was on a web page, viewed the consent text, and requested to be contacted.

In a further related embodiment of the computer-implemented method for lead capture, certification, and distribution, the step of processing a submission 410, can further employ a double opt-in email solution that further verifies intent by emailing consumers after a web-form submission and confirming their intent.

FIG. 1 shows a depiction of an embodiment of the lead certification server 102. In this relation, a server shall be understood to represent a general computing capability that can be physically manifested as one, two, or a plurality of individual physical computing devices, located at one or several physical locations. A server can for example be manifested as a shared computational use of one single desktop computer, a dedicated server, a cluster of rack-mounted physical servers, a datacenter, or network of datacenters, each such datacenter containing a plurality of physical servers, or a computing cloud, such as the Amazon EC2, or Microsoft Azure.

It shall be understood that the above-mentioned components of the lead certification server 102 and the lead certification device 120 are to be interpreted in the most general manner.

For example the processor 202 and the processor 302, can each respectively include a single physical microprocessor or microcontroller, a cluster of processors, a datacenter or a cluster of datacenters, a computing cloud service, and the like.

In a further example, the memory 204 and the memory 304 can each respectively include various forms of non-transitory storage media, including random access memory and other forms of dynamic storage, and hard disks, hard disk clusters, cloud storage services, and other forms of long-term storage. Similarly, the input/output 206 and the input/output 306 can each respectively include a plurality of well-known input/output devices, such as screens, keyboards, pointing devices, motion trackers, communication ports, and so forth.

Furthermore, it shall be understood that the lead certification server 102 and the lead certification device 120 can each respectively include a number of other components that are well known in the art of general computer devices, and therefore shall not be further described herein. This can include system access to common functions and hardware, such as for example via operating system layers such as Windows, Linux, and similar operating system software, but can also include configurations wherein application services are executing directly on server hardware or via a hardware abstraction layer other than a complete operating system.

In related embodiments, the lead certification server 102 and the lead certification device 120 can each respectively be part of a general computer, such as a personal computer (PC), a tablet, a notebook, a laptop, a workstation, a server, a mainframe computer, a smart phone, a mobile device, a smart television, an embedded processor in a vehicle, machine, or building structure, a similar device, or some combination of these. Such a general computer can include a memory, a processor, input/out components, and other components that are common for general computers, all of which are well known in the art and therefore will not be further elaborated or described herein.

Additionally, in related embodiments the lead certification device 120; executing in a computational environment, such as for example a web browser or a general computer; can communicate information to the user and request user input by way of an interactive, menu-driven, visual display-based user interface, or graphical user interface (GUI). The user interface can be executed, for example, on a smartphone with a touch sensitive screen, and screen based keyboard, with which the user may interactively input information using direct manipulation of the GUI. Direct manipulation can include the use of a pointing device, such as a mouse, a stylus, or a touch sensitive screen, to select from a variety of selectable fields, including selectable menus, drop-down menus, tabs, buttons, bullets, checkboxes, text boxes, and the like. Nevertheless, various embodiments of the lead certification system may incorporate any number of additional functional user interface schemes in place of this interface scheme, with or without the use of a mouse or buttons or keys, including for example a trackball or a touch screen.

In a related embodiment, the lead certification server 102 communicates with the lead certification device 120 over a network 112, which can include the general Internet, a Wide Area Network or a Local Area Network, or another form of communication network, transmitted on wired or wireless connections. Wireless networks can for example include Ethernet, Wi-Fi, Bluetooth, ZigBee, and NFC.

FIGS. 1, 2, 3 and 4 are block diagrams and flowcharts of methods, devices, systems, apparatuses, and computer program products according to various embodiments of the present invention. It shall be understood that each block or step of the block diagram, flowchart and control flow illustrations, and combinations of blocks in the block diagram, flowchart and control flow illustrations, can be implemented by computer program instructions or other means. Although computer program instructions are discussed, an apparatus or system according to the present invention can include other means, such as hardware or some combination of hardware and software, including one or more processors or controllers, for performing the disclosed functions.

In this regard, FIGS. 2 and 3 depict the computer devices of various embodiments, each containing several of the key components of a general-purpose computer by which an embodiment of the present invention may be implemented. Those of ordinary skill in the art will appreciate that a computer can include many components. However, it is not necessary that all of these generally conventional components be shown in order to disclose an illustrative embodiment for practicing the invention. The general-purpose computer can include a processing unit and a system memory, which may include random access memory (RAM) and read-only memory (ROM). The computer also may include nonvolatile storage memory, such as a hard disk drive, where additional data can be stored.

An embodiment of the present invention can also include one or more input or output components, such as a mouse, keyboard, monitor, and the like. A display can be provided for viewing text and graphical data, as well as a user interface to allow a user to request specific operations. Furthermore, an embodiment of the present invention may be connected to one or more remote computers via a network interface. The connection may be over a local area network (LAN) wide area network (WAN), and can include all of the necessary circuitry for such a connection.

Typically, computer program instructions may be loaded onto the computer or other general-purpose programmable machine to produce a specialized machine, such that the instructions that execute on the computer or other programmable machine create means for implementing the functions specified in the block diagrams, schematic diagrams or flowcharts. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the block diagrams, schematic diagrams or flowcharts.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the block diagram, schematic diagram, flowchart block or step.

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagrams, schematic diagrams or flowcharts, as well as combinations of blocks or steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

The many features and advantages of the invention are apparent from the detailed specification, and thus, it is intended by the appended claims to cover all such features and advantages of the invention, which fall within the true spirit and scope of the invention.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A lead certification system for lead capture, lead certification, and lead distribution, comprising:
a. a lead certification server; and
b. a lead certification database;
wherein the lead certification server dynamically generates a consent agreement text from processing of a lead capture form, based on consumer information stored and issued from the lead certification database, such that event capture information is stored, via the lead certification server, in the lead certification database, to validate that a user, the user identified via an internet protocol address, was served the consumer information on a web site and that the consumer information was displayed at the time the lead capture form was submitted to a server with a database for capturing and storing this information.

2. The lead certification system of claim 1, further comprising
a. a lead certification device;
wherein the lead certification device processes display of the agreement text and storage of the event capture information.

3. The lead certification system of claim 2, wherein the lead certification server further comprises:
a. a server processor;
b. a server memory;
c. an server input/output component;
d. a lead management component; all connected via
e. a data bus;
wherein the lead management component is configured to generate the lead capture form, including the consent agreement text, based on information stored and issued from the lead certification database, and further stores, retrieves and processes, the lead capture form and the event capture information in the lead certification database.

4. The lead certification system of claim 3, wherein the lead management component is further configured to generate a lead generated tracking code snippet for tracking the user, such that the lead generated tracking code snippet is retrieved by the lead certification device from the lead certification server, via the server input/output, such that the lead generated tracking code snippet is processed by the lead certification device.

5. The lead certification system of claim 1, wherein the lead certification server further comprises a lead distribution component, which is configured with a geolocation function to determine and store the approximate physical location associated with the user's internet protocol address.

6. The lead certification system of claim 5, further comprising a phone switch, such that the lead distribution component is further configured to validate that a consumer has provided consent by lookup in the lead certification database, and if consent is confirmed, connect a call to the consumer via communication with the phone switch.

7. The lead certification system of claim 5, wherein the lead distribution component is further configured to determine and store a phone number type for a primary phone number entered through the lead certification form.

8. The lead certification system of claim 5, wherein the lead distribution component is further configured to process a double opt-in email procedure, wherein the lead distribution component sends a template driven verification email to an email address supplied with the lead information, such that the verification email contains a web link, wherein the link provides a log of the consent acquired.

9. The lead certification system of claim 8, wherein the verification email further comprises questions, whereby answers to the questions are used to track intent to purchase, intent to use, and intent to subscribe to products and services.

10. The lead certification system of claim 8, wherein the web link is associated with a template driven landing page, such that when the web link is clicked via an email client of the user, a date and time stamp for the user's click action, and associated information captured by the landing page is stored by the lead certification server in the lead certification database.

11. The lead certification system of claim 8, wherein the lead distribution component is further configured to send a form completion response back to the lead certification device, for presentation of a result to the user.

12. The lead certification system of claim 2, wherein the lead certification device comprises:
a. a device processor;
b. a device memory;
c. a device input/output component;
d. a content display component; all connected via
e. a data bus;
wherein computer generated content is displayed to a customer to convey information about products being offered for the purpose of collecting contact information.

13. The lead certification system of claim 12, wherein the lead certification device further comprises:
a. an information capture component, configured to present the user with an information capture screen that collects information related to the user, such that the information is stored in the device memory.

14. The lead certification system of claim 13, wherein the information capture component is further configured to retrieve a lead form capture code snippet from the lead certification server, such that the lead form capture code snippet is executed by the device processor and communicates with the lead certification server.

15. The lead certification system of claim 14, wherein the lead certification device further comprises:
a. a submission processor component, configured to process the information captured by the information capture component, and further communicate the information to the lead management of the lead certification server, via the server input/output component.

16. A lead certification device, comprising:
a. a device processor;
b. a device memory;
c. a device input/output component;
d. a content display component; and
e. an information capture component; all connected via
f. a data bus;
wherein the content display component is configured to display computer generated content to a customer to convey information about products being offered for the purpose of collecting contact information; and
wherein the information capture component is configured to present the user with an information capture screen that collects information related to the user, such that the information is stored in the device memory.

17. The lead certification device of claim 16, wherein the information capture component is further configured to retrieve a lead form capture code snippet from the lead certification server, such that the lead form capture code snippet is executed by the device processor and communicates with the lead certification server.

18. The lead certification device of claim 16, wherein the lead certification device further comprises:
a. a submission processor component, configured to process the information captured by the information capture component, and further communicate the information to the lead management of the lead certification server, via the server input/output component.

19. A computer-implemented method for lead capture, certification, and distribution, comprising:
a. displaying content;
b. capturing information, wherein information about a consumer is captured, such that the information further comprises including analytic information;
c. obtaining consent, wherein a provider's consent text is served to the consumer on a web form, a consent approval status is indicated by the consumer, and it is verified that the consumer consent text was viewed by consumer in association with a submission, and a unique certification identification for the submission and the consent approval status is stored in a non-transient memory.

20. The computer-implemented method for lead capture, certification, and distribution of claim 19, wherein the action of obtaining consent further comprises:
i. a real-time phone verification, which provides a reverse look up on a submitted land-line phone number, and indication if it is a mobile phone number;
ii. an internet protocol address verification, which is used as a unique consumer identity verification, to ensure that the consumer matches the submission;
iii. storing copies of a landing page URL, analytic information, and the consent text for a pre-determined length of time; and
iv. printing the consent text and associated information, to show proof that the consumer was on the web page, viewed the consent text, and requested to be contacted.

21. The computer-implemented method for lead capture, certification, and distribution of claim 19, further comprising:
d. processing a submission, wherein a double opt-in email process further verifies intent by emailing the consumer after a submission, thereby confirming their intent.
